(19) United States
(12) Patent Application Publication
(10) Pub. No.: US 2009/0093285 A1
(43) Pub. Date: Apr. 9, 2009

(54) Bilateral sliding module and the electronic device using the same

(75) Inventors: Chen-Ying Weng, Taipei City (TW); Jiung-Cheng Pan, Tainan City (TW)

Correspondence Address: COVENANT IP CONSULTING CO., P.O. BOX 34-306 TAIPEI CITY, TAIPEI, 10499, TW

(73) Assignee: BENQ CORPORATION, Taipei City (TW)

(21) Appl. No.: 12/245,703

(22) Filed: Oct. 4, 2008

(30) Foreign Application Priority Data
Oct. 5, 2007 (TW) 096137424

(51) Int. Cl. H04M 1/00

(52) U.S. Cl. 455/575.4

(57) ABSTRACT

A bilateral sliding module and an electronic device using the same are provided. The electronic device has a top housing, a bottom housing, and the bilateral sliding module slidable connects the top housing to the bottom housing. The bilateral sliding module comprises a first guiding unit, a second guiding unit and a cross-moving device. In which, the first guiding unit is disposed on the top housing, and the second guiding unit is disposed on the bottom housing opposite the first guiding unit. The cross-moving device is disposed between the first guiding unit and the second guiding unit, such that the top housing and the bottom housing are cross-movably coupled.

### BACKGROUND OF THE INVENTION

1. Field of the Invention

This invention relates to a bilateral sliding module; more particularly, this invention relates to a bilateral sliding module and the electronic device using the same, which gives more room for a larger keypad so as to increase the convenience of inputting.

2. Description of the Prior Art

Because more and more smart phones want to simulate the convenience of a personal computer (PC), they all adopt qwerty keypad to increase the message and input functions of a mobile phone. However, due to the limitation of the dimension of the mobile phone, the operating convenience is sacrificed for the limitation of the dimension of the inputting area. Therefore, finding the balance point between the limitation of the dimension of the mobile phone and the convenience of inputting has become a critical point of designing a smart phone.

FIG. 1a and FIG. 1b illustrate the keypad sliding module widely used in smart phone, UMPC and the like portable electronic device. As shown in FIG. 1a, the electronic device 10 includes a top housing 11 and a bottom housing 12; the top housing 11 is equipped with a display and the bottom housing is equipped with an input keypad. As shown in FIG. 1b, the keypad sliding module 20 constituted by a guiding track and a trough is disposed between the top housing 11 and the bottom housing 12. As shown in FIG. 1a and 1b, the top housing 11 can be slid with respect to the bottom housing 12 using the guiding track and trough of the keypad sliding module 20 to cross move. However, in order to take account of the rigidity of the coupling between the top housing 11 and the bottom housing 12, a part of the side of the bottom housing 12 very often has to be sacrificed to be coupled to the top housing 11, such that the operating area of the input keypad is decreased, which is less convenient for the user.

### SUMMARY OF THE INVENTION

The major object of this invention is to offer a bilateral sliding module and the electronic device using the same, which gives more room for a larger keypad and offers the portable electronic device such as smart phone and UMPC larger keypad operating area to increase the convenience of inputting.

Another object of this invention is to provide a bilateral sliding module and the electronic device using the same, which can carry out the movement of moving towards each other simultaneously; in addition to offering the consumer a novel using method, this design also increases the operating convenience and improved application.

Yet another object of this invention is to provide a bilateral sliding module and the electronic device using this module. While the user horizontally pushing the display on talk mode, the bottom input keypad can be simultaneously moved in the other direction and transferred to type mode when the keypad reaches the end.

The bilateral sliding module of this invention and the electronic device using this module, wherein the electronic device has a top housing and a bottom housing and the bilateral sliding module comprises a first guiding unit, a second guiding unit and a cross-moving device. In which, the first guiding unit is disposed on the top housing and the second guiding unit is disposed on the bottom housing opposite the first housing, and the cross-moving device is disposed between the first guiding unit and the second guiding unit, so as to cross-movably couple the first guiding unit and the second guiding unit; moreover, the top housing and the bottom housing are slidable back and forth between the receiving position and the opening position. In the preferred embodiment, the first guiding unit comprises a bottom surface disposed with the first rack, and the second guiding unit comprises a top surface disposed with the second rack provided for driving the cross-moving device; the cross-moving device comprises a bearing and one end of the bearing is coupled to the gear wheel, and the gear wheel is rotatable around the axial direction of the bearing and rotatably coupled to the racks of the first guiding unit and the second guiding unit, such that the first guiding unit and the second guiding unit are cross-slidable with respect to each other.

### BRIEF DESCRIPTION OF THE DRAWINGS

FIG. 1a illustrates a conventional sliding module and an electronic device using the sliding module;

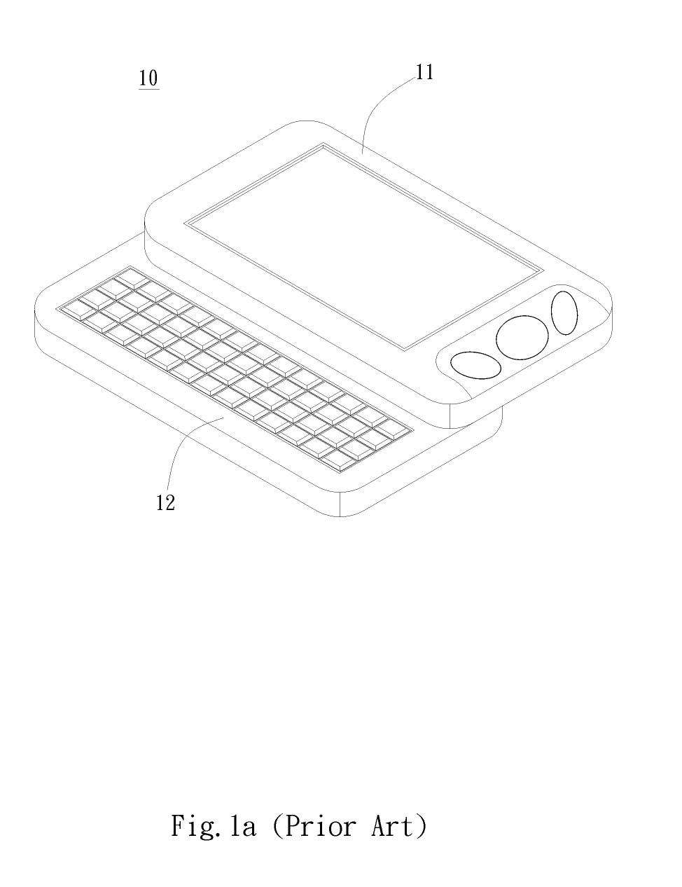

FIG. 1b illustrates the other view of the conventional sliding module and an electronic device shown in FIG. 1a;

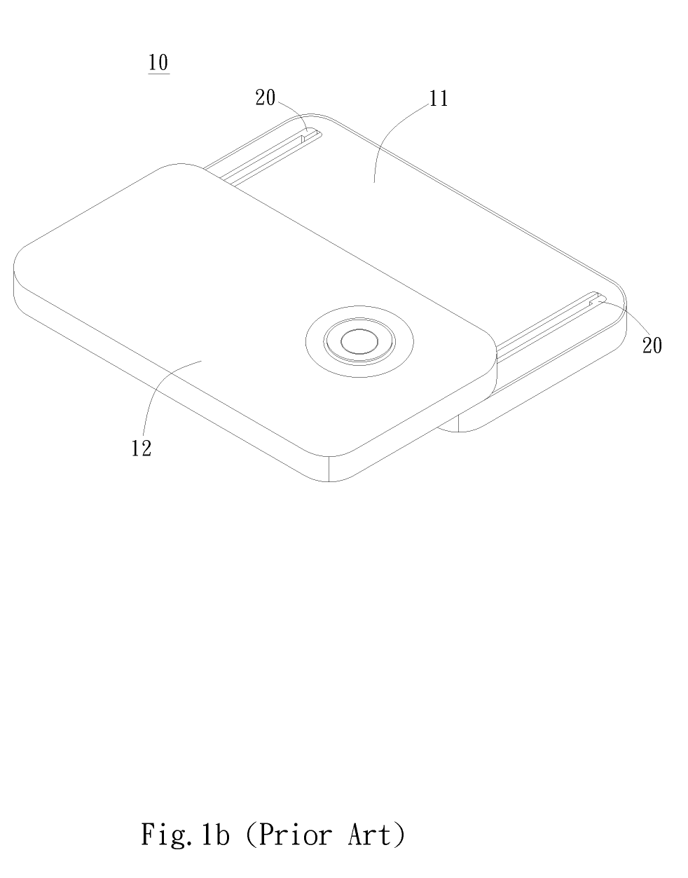

FIG. 2 illustrates a perspective view of an embodiment of the bilateral sliding module and the electronic device using this module;

FIG. 3a shows an operation mode of the bilateral sliding module and the electronic device shown in FIG. 2;

FIG. 3b illustrates a partially perspective view of the bilateral sliding module and the electronic device shown in FIG. 3a;

FIG. 3c shows a top view of the bilateral sliding module and the electronic device shown in FIG. 2 and FIG. 3a;

FIG. 4 shows an exploded view of the bilateral sliding module and the electronic device shown in FIG. 2;

FIG. 5 shows a corresponding movement between the first housing and the second housing of the electronic device.

### DETAILED DESCRIPTION OF THE PREFERRED EMBODIMENT

This invention provides a bilateral sliding module and the electronic device using the same, which can provide larger room for operating the keypad, providing larger keypad operating area for portable electronic device, such as smart phone and UMPC to increase the convenience of inputting. However, in other embodiments, the bilateral sliding module of this invention is applicable to other inputting device other than keypad, such as handwriting recognition board, trackpad (touchpad) and other non-inputting device such as lens. The bilateral sliding module of this invention and the electronic device using this module are preferably moved in the opposite directions, which not only offer consumers a novel operating method, but also increase the convenience of use and improved application. The electronic device described herein is preferably referred to a portable electronic device, such as a smart phone, an Ultra Mobile PC, a PDA, a GPS or a Mobile Computer.

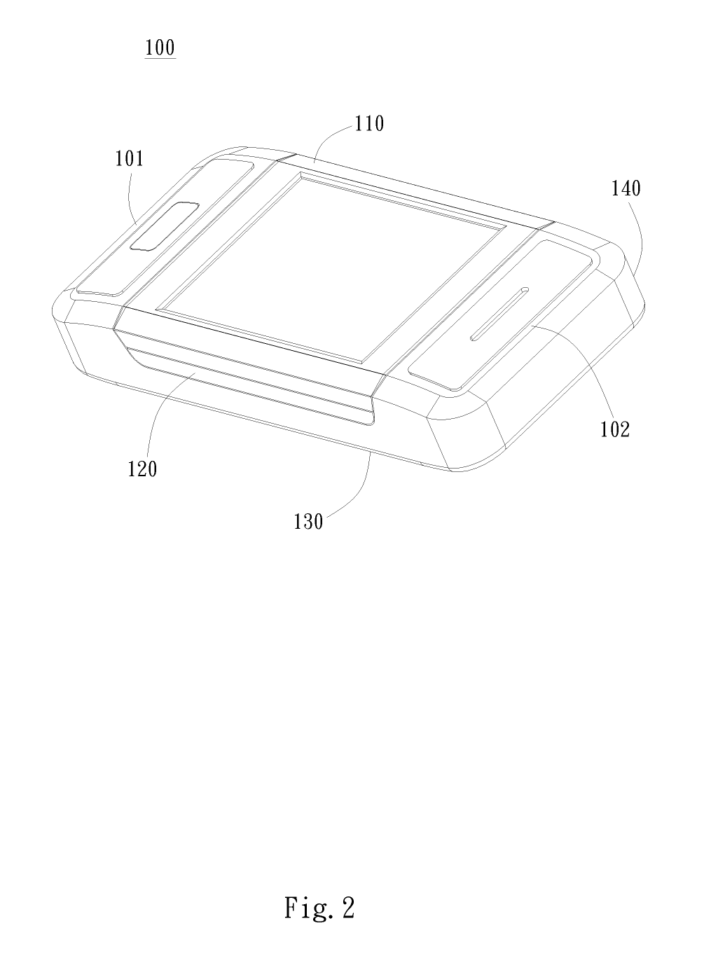

FIG. 2 illustrates an embodiment of the bilateral sliding module of this invention and the electronic device using this module. As illustrated in the embodiment of FIG. 2, the electronic device 100 using the bilateral sliding module of this invention has a top housing 110, a bottom housing 120 and a main housing including an outer housing 140 and a base 130. As the embodiment shown in FIG. 2, the outer housing 140 is preferably disposed on the base 130, and the top surface of the outer housing 140 sinks inwardly to form a hollow receiving recess between the first end 101 and the second end 102 of the electronic device 100. The hollowing receiving recess is provided for receiving the top housing 110 and the bottom housing 120. As illustrated in the embodiment shown in FIG. 2, the top housing 110 is disposed on part of top surface of the outer housing 140 and slidably coupled to the outer housing 140 of the electronic device 100. As illustrated in FIG. 2, the top housing 110 and the bottom housing 120 are preferably stacked and disposed on the base 130 of the electronic device 100. The bottom housing 120 can be received and disposed between the top housing 1 10 and outer housing 140 and is slidable relative to the top housing 110.

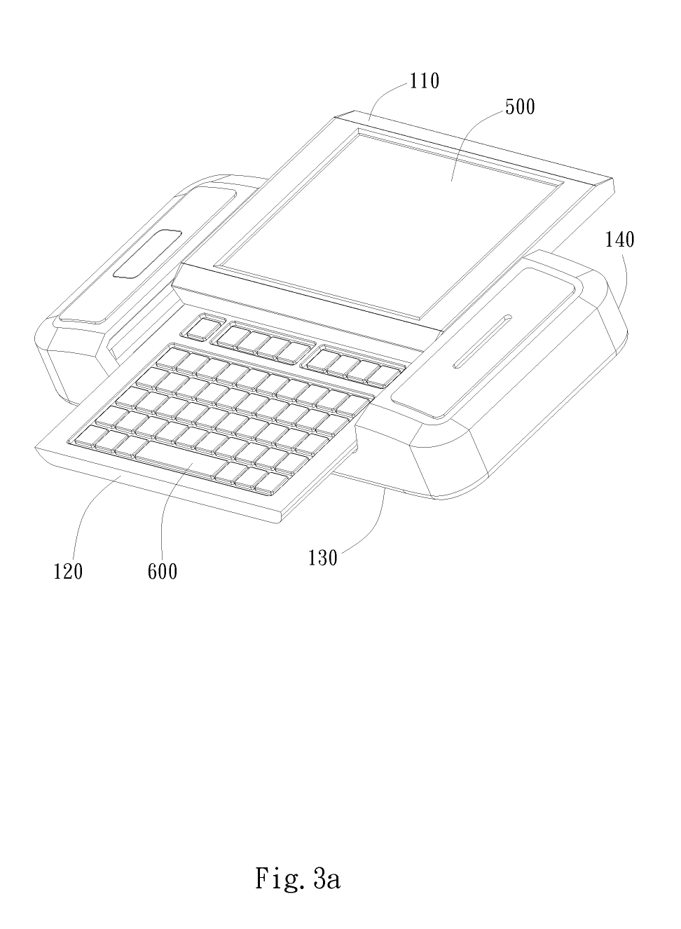

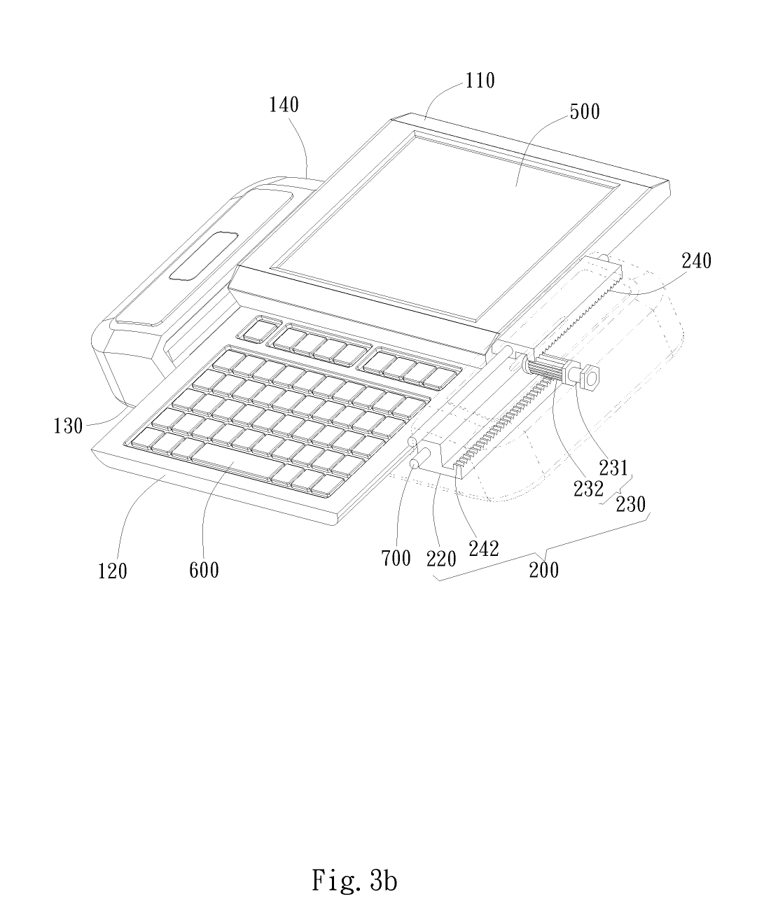

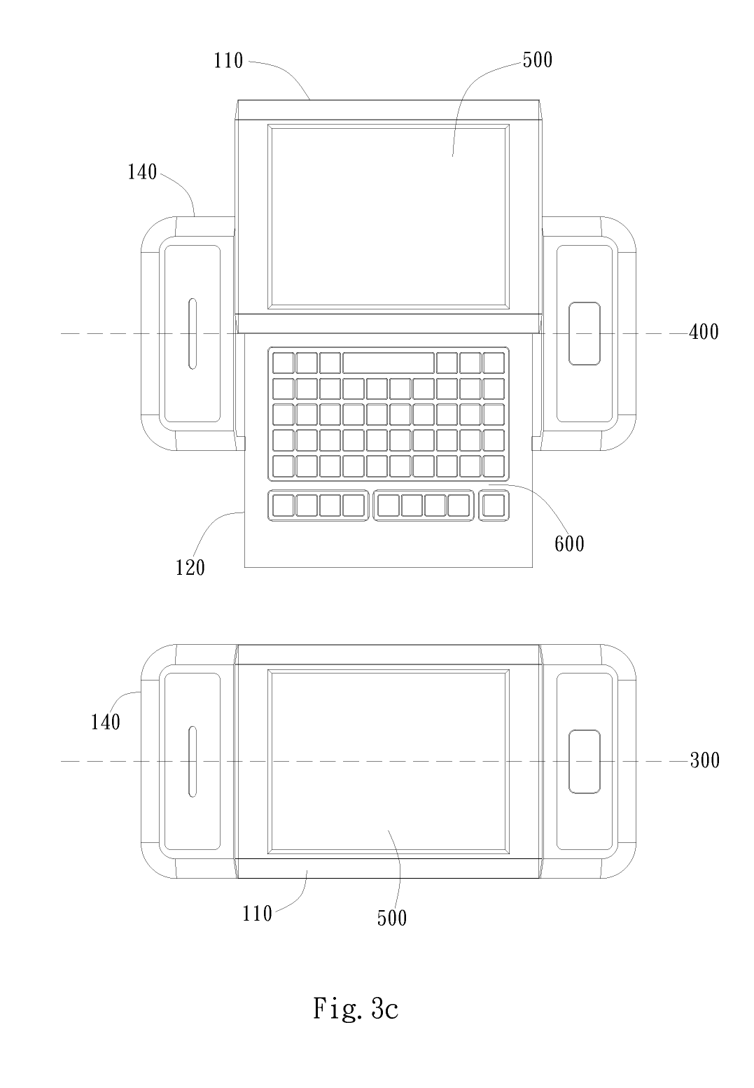

As illustrated in the embodiment of FIG. 3a, the top housing 110 includes a display portion 500 while the bottom housing 120 includes an input portion 600. The display portion 500 described herein is preferably referred to display panels, such as TFT-LCD and OLED; the input portion 600 described herein is preferably referred to an inputting keyboard or an inputting device, such as qwerty keyboard and trackpad (touchpad). In the embodiment illustrated in FIG. 3b, the top housing 110 and the bottom housing 120 simultaneously and respectively slide in two directions by means of the bilateral sliding module 200 disposed between the base 130 and the outer housing 140. As illustrated in the embodiment of FIG. 3b, the bilateral sliding module 200 is disposed on the second end 102 of the electronic device 100 and coupled to the edges of the top housing 110 and the bottom housing 120. Such arrangement not only provides a stable connection between the top housing 110 and the bottom housing 120 but also save the space in the bottom housing 120. In addition, the top housing 110 and the bottom housing 120 simultaneously and respectively slide in two opposite directions, so that the exposed area of the keypad operating area is getting bigger.

As illustrated in FIG. 3b, the bilateral sliding module 200 is preferably disposed inside the electronic device 100 and has a first guiding unit 210, a second guiding unit 220 and a cross moving device 230. As illustrated in the embodiment of FIG. 3b, the first guiding unit 210 is disposed adjacent to the top housing 110 and coupled to the edge of the top housing 110, and the second guiding unit 220 is disposed on the bottom housing 120 opposite to the first guiding unit 210. In the preferred embodiment shown in FIG. 3b, the cross-moving device 230 is disposed between the first guiding unit 210 and the second guiding unit 220, such that the top housing 110 and the bottom housing 120 are cross-movably coupled. The phrase “cross-movably coupled” described herein is preferably referred to that the cross-moving device 230 simultaneously generates respective displacements relative to the top housing 110 and the bottom housing 120 with an equal distance but in different directions, such that the housing 110 and the bottom housing 120 are capable of sliding back and forth simultaneously in the opposite directions between the receiving position 300 and the opening position 400, as illustrated in FIG. 3b and 3c. However, in other embodiments, it is also possible to simultaneously generate the respective displacements with different distances and different directions relative to the top housing 110 and the bottom housing 120.

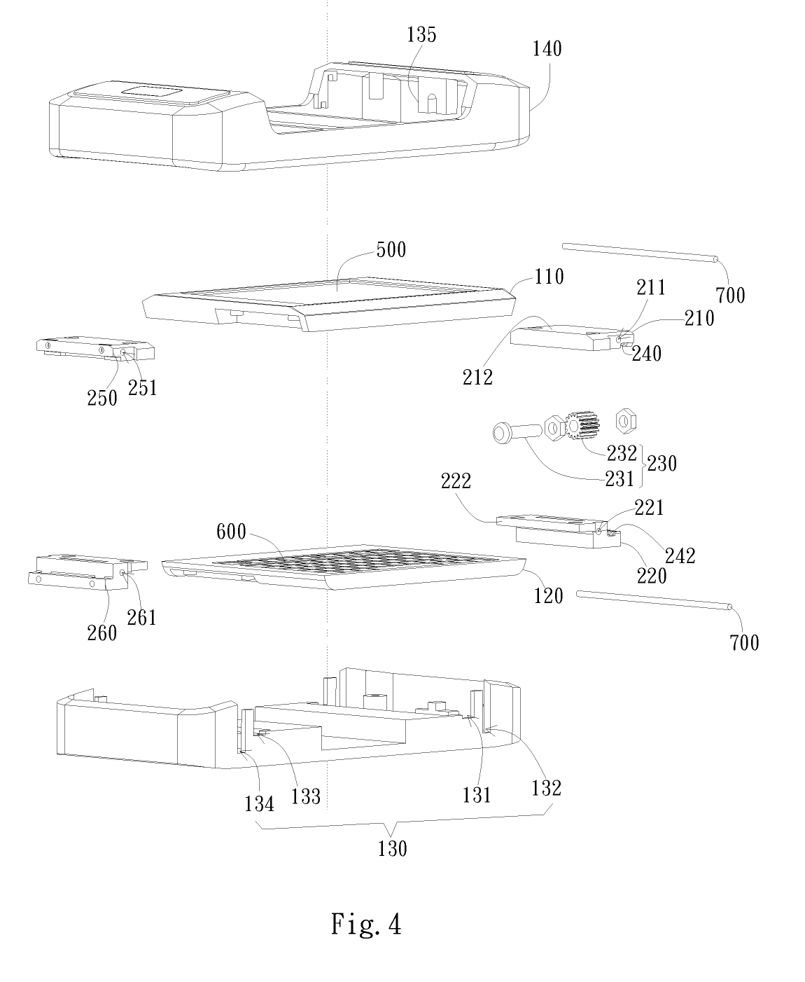

As illustrated in the preferred embodiment of FIG. 4, the first guiding unit 210 includes a first coupling portion 212 provided for coupling with the edge of the top housing 110, and the second guiding unit 220 also includes a second coupling portion 222 provided for coupling the edge of the bottom housing 120. As illustrated in FIG. 4, the first coupling portion 212 of the first guiding unit 210 is preferably coupled to a part of the bottom surface of the top housing 110 by screw, and the top housing 110 and the cross-moving device 230 are movably coupled. However, in other embodiments, it is also possible for the first guiding unit 210 to be coupled to the top housing 110 by riveting or adhering. Moreover, in other embodiments, the first guiding unit 210 and the top housing 110 can be integratedly formed by injection molding. Likewise, in the embodiment illustrated in FIG. 4, the second coupling portion 222 of the second guiding unit 220 is preferably coupled to a part of top surface of the bottom housing 120 by screw, and the bottom housing 120 is movably coupled to the cross-moving device 230. However, in other embodiments, the second guiding unit 220 is also possible to be coupled to the bottom housing 120 by riveting or adhering. Moreover, in other embodiments, the second guiding unit 220 can be integratedly formed by injection molding.

As illustrated in FIG. 4, the first guiding unit 210 preferably includes a first rack 240 disposed on the bottom surface of the first guiding unit 210 while the second guiding has a second rack 242 disposed on the top surface of the second guiding unit 220. The first rack 240 and the second rack 242 are provided for respectively driving the cross-moving device 230 to rotate between the first guiding unit 210 and the second guiding unit 220. As illustrated in the preferred embodiment of FIG. 4, the cross-moving device 230 comprises a bearing 231. One end of the bearing 231 is preferably coupled to a gear wheel 232, and the cross-moving device 230 is rotatably coupled to the first guiding unit 210 and the second guiding unit 220 by the engagement between the gear wheel 232, the first rack 240, and the second rack 242. As illustrated in the embodiment of FIG. 4, the gear wheel 232 is rotatable around the bearing 231, such that the first guiding unit 210 and the second guiding unit 220 are slidable respectively along different directions. In the preferred embodiment, the cross-moving device further includes a driving module which provides force to compel the first guiding unit 210 and the second guiding unit 220 to slide between the receiving position 300 and the opening position 400. The driving module preferably includes a power unit, such as a tension spring. In other embodiments, however, driving module may also comprises a pair of magnetic entities disposed in the way of facing each other for providing a magnetic force to separate the first guiding unit 210 and the second guiding unit 220. Moreover, in other embodiments, the driving module also comprises a drive motor and elastic belt as the power unit.

As illustrated in FIG. 4, the bilateral sliding module 200 preferably further comprises a third guiding unit 250 and a fourth guiding unit 260 disposed opposite to each other. The third guiding unit 250 is disposed on the top housing 110, and the fourth guiding unit 260 is disposed on the bottom housing 120 opposite to the third guiding unit 250. As illustrated in the preferred embodiment of FIG. 4, the third guiding unit 250 and the first guiding unit 210 are disposed in parallel on the top housing 110, and the fourth guiding unit 260 and the second guiding unit 220 are disposed in parallel on the bottom housing 120. As illustrated in FIG. 4, the third guiding unit 250 and the fourth guiding unit 260 are preferably coupled to the other edge of the top housing 110 and the bottom housing 120 respectively. As illustrated in the preferred embodiment of FIG. 4, the third guiding unit 250 is preferably coupled to a part of the bottom surface of the top housing 110. However, in other embodiments, the third guiding unit 250 can also be coupled to the top housing 110 by riveting or adhering. Moreover, in other embodiments, the third guiding unit 250 is formed as a whole by injection molding. Likewise, as the embodiment illustrated in FIG. 4, the fourth guiding unit 260 is preferably coupled to the part of the top surface of the bottom housing 120. However in other embodiments, the second guiding unit 220 and the bottom housing 120 can also be coupled by riveting or adhering. Moreover, in other embodiments, the fourth guiding unit 260 can be formed as a whole by injection molding.

As illustrated in the embodiment of FIG. 4, a bearing block 135 is preferably disposed on an inner side of the outer housing 140 of the electronic device 100. The bearing block 135 is pivotally coupled to the other end of the bearing 230 to position the bearing 230 between the outer housing 140 and the base 130 and to allow the gear wheel 232 rotating around the axial direction of the bearing 231. However, in other embodiments, the bearing block 135 can also be disposed on the base 130 and together position the bearing 230 in the electronic device 100 with the outer housing 140. As illustrated in the preferred embodiment of FIG. 4, the base 130 has a first guiding trough 131 provided for working with the guiding rod 700 to position the first guiding unit 210 between the base 130 and the outer housing 140. As illustrated in FIG. 4, the first guiding unit 210 preferably further comprises a sliding track trough 211 slidably coupled to the guiding rod 700 and engaged with the first guiding trough 131 with a guiding rod 700 to position the sliding position of the top housing 110 on the electronic device 100.

As illustrated in the embodiment of FIG. 4, base 130 has a second guiding trough 132 provided for working with the guiding rod 700 to position the second guiding unit 220 between the base 130 and the outer housing 140. As illustrated in FIG. 4, the second guiding unit 220 preferably further comprises a sliding trough 221 slidably coupled to the guiding rod 700, and position the bottom housing 120 at the sliding position on the electronic device 100 by the guiding rod 700 being engaged with the second guiding trough 132.

As illustrated in FIG. 4, base 130 preferably further includes a third guiding trough 133 provided for working with the guiding rod 700 to position the third guiding unit 250 between the base 130 and the outer housing 140. As illustrated in FIG. 4, the third guiding unit 250 preferably further comprises a sliding trough 251 slidably coupled to the guiding rod 700, and engaged with the third guiding trough 133 with the guiding rod 700 to position the top housing 110 on the sliding position on the electronic device 100. As illustrated in the preferred embodiment of FIG. 4, base 130 preferably further includes a fourth guiding trough 134 provided for working with the guiding rod 700 to position the fourth guiding unit 260 between the base 130 and the outer housing 140. As illustrated in FIG. 4, the fourth guiding unit 260 preferably further comprises a sliding trough 261 slidably coupled to the guiding rod 700, and position the bottom housing 120 on the sliding position on the electronic device 100 by the guiding rod 700 being engaged with the fourth guiding trough 134.

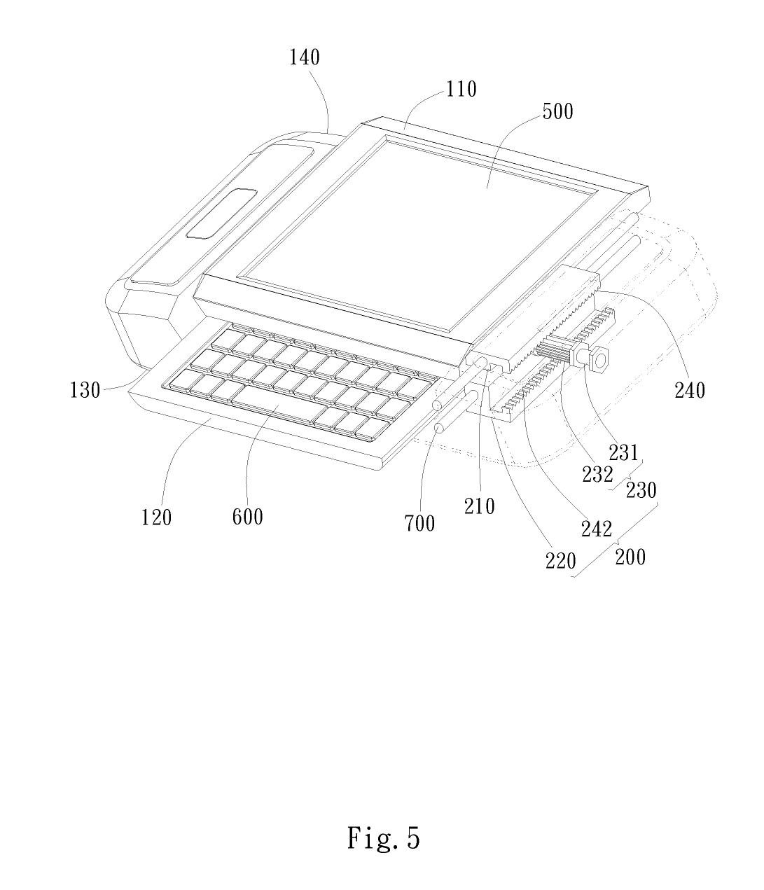

As illustrated in the embodiment of FIG. 5, with the first guiding unit 110 and the second guiding unit 120 of the bilateral sliding module 200 moving in the opposite directions using the cross-moving device 230, the top housing 110 and the bottom housing 120 of the electronic device 100 is capable of simultaneously moving in the opposite directions, which not only increases the convenience when a user inputs the text or outputs the message, but also improves the applicability of the electronic device. When the user pushes the display horizontally in a phone mode or call mode, the input keypad below also moves simultaneously in the opposite direction, and the electronic device 100 is switched to a typing mode when the sliding module is moved to the end. As illustrated in the embodiments of FIG. 5, the arrangement of this kind of sliding module provides sufficient stability between the top housing 110 and the bottom housing 120 and does not need to sacrifice a part of space in the bottom housing 120 for coupling to the top housing 110. Therefore, a larger keypad area can be obtained comparing to former designs.

This invention has been described with the embodiments above; however, the embodiments above are only exemplary. What needs to point out is that the disclosed embodiments did not limit the scope of this invention. Conversely, the spirit included in the claims and the modification of the scope and the equivalents are all included in the scope of this invention.

What is claimed is:

1. A bilateral sliding module provided for an electronic device having a top housing and a bottom housing, the bilateral sliding module comprising:
a first guiding unit, disposed on the top housing;
a second guiding unit, disposed on the bottom housing, opposite to the first guiding unit; and
a cross-moving device, disposed between the first guiding unit and the second guiding unit, wherein the top housing and the bottom housing are slidably movable back and forth between a receiving position and an opening position, wherein the first guiding unit moves along the first direction and drives the cross-moving device, and the cross-moving device drives the second guiding unit to move along the second direction when the bilateral sliding module is from the receiving position to the opening position.

2. The bilateral sliding module of claim 1, wherein the second direction is opposite to the first direction.

3. The bilateral sliding module of claim 1, wherein the top housing includes a display portion, and the bottom housing includes an input portion.

4. The bilateral sliding module of claim 1, wherein the first guiding unit includes a first coupling portion provided for coupling with the top housing, and the second guiding unit includes a second coupling portion provided for coupling with the bottom housing.

5. The bilateral sliding module of claim 1, wherein the cross-moving device includes a bearing, and the end of the bearing is coupled to a gear wheel, and the gear wheel is rotatable around the axial direction of the bearing and rotatably coupled to the first guiding unit and the second guiding unit, such that the first guiding unit and the second guiding unit are cross-slidable with respect to each other.

6. The bilateral sliding module of claim 5, wherein the first guiding unit has a first rack disposed at a bottom surface of the first guiding unit provided for driving the cross-moving device, and the second guiding unit has a second rack disposed at a top surface of the second guiding unit provided for driving the cross-moving device.

7. The bilateral sliding module of claim 1, further comprising a third guiding unit and a fourth guiding unit corresponding to each other, the third guiding unit disposed on the top housing and the fourth guiding unit disposed on the bottom housing opposite the third guiding unit, wherein the third guiding unit is parallel to the first guiding unit, and the fourth guiding unit is parallel to the second guiding unit.

8. An electronic device including a top surface and a bottom surface, comprising:
a top housing disposed on the top surface;
a bottom housing being slidable with respect to the top housing; and
a bilateral sliding module, including:
a first guiding unit, disposed on the top housing; and
a second guiding unit, disposed on the bottom housing, opposite to the first guiding unit; and
a cross-moving device, disposed between the first guiding unit and the second guiding unit, such that the top housing and the bottom housing are cross-movably coupled, wherein the top housing and the bottom housing are slidably movable back and forth between a receiving position and an opening position, wherein the first guiding unit moves along the first direction and drives the cross-moving device and the cross-moving device drives the second guiding unit along the second direction when the bilateral sliding module is from the receiving position to the opening position.

9. The electronic device of claim 8, wherein the top housing includes a display portion, and the bottom housing includes an input keyboard.

10. The electronic device of claim 8, wherein the first guiding unit includes a first coupling portion provided for coupling the top housing, and the second guiding unit includes a second coupling portion provided for coupling with the bottom housing.

11. The electronic device of claim 8, wherein the electronic device further comprises a housing, and the cross-moving device includes a bearing disposed on the housing and the one end of the bearing is coupled to a gear wheel, and the gear wheel is rotatable around the axial direction of the bearing; and rotatably coupled to the first guiding unit and the second guiding unit, such that the first guiding unit and the second guiding unit are cross-slidable with respect to each other.

12. The electronic device of claim 11, wherein the first guiding unit has a first rack disposed on the bottom surface of the electronic device provided for driving the cross-moving device, and the second guiding unit has a second rack disposed on the top surface provided for driving the cross-moving device.

13. The electronic device of claim 11, the housing includes a bearing block being pivotally coupled to the other end of the bearing.

14. The electronic device of claim 8, further comprising a first guiding trough and a second guiding trough, and the first guiding unit is slidably coupled to the first guiding trough and positioned to the top housing, and the second guiding unit is slidably coupled to the second guiding trough and positioned to the bottom housing.

15. The electronic device of claim 8, further comprising a third guiding unit and a fourth guiding unit disposed opposite to each other, the third guiding unit disposed on the top housing, the fourth guiding unit disposed on the bottom housing, wherein the third guiding unit is parallel to the first guiding unit, and the fourth guiding unit is parallel to the second guiding unit.

16. The electronic device of claim 15, wherein the housing comprises a third guiding trough and a fourth guiding trough, and the third guiding unit is slidably coupled to the third guiding trough and positioned to the top housing and the fourth guiding unit is slidably coupled to the fourth guiding trough and positioned to the bottom housing.
